(19) United States
(12) Patent Application Publication
(10) Pub. No.: US 2004/0024631 A1
(43) Pub. Date: Feb. 5, 2004

(54) Method of and apparatus for service operation management, and computer product

(75) Inventors: Suehiro Orita, Kawasaki (JP); Hisaaki Goto, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/331,933

(22) Filed: Dec. 31, 2002

(30) Foreign Application Priority Data
Aug. 2, 2002 (JP) 2002-226751

(51) Int. Cl. G06F 17/60

(52) U.S. Cl. 705/9

(57) ABSTRACT

When a request for receiving certain service is received from any one of a plurality of users, depending on the service, an advertisement is made for recruiting a service person. The service persons who have applied for the advertisement are authenticated and an authentic service person is dispatched to the user to provide the service.

### BACKGROUND OF THE INVENTION

1) Field of the Invention

The present invention relates to a technology for managing various kinds of services. The services may include maintenance of computers, setting of computers, installation of application programs etc.

2) Description of the Related Art

Conventionally, in an equipment maintenance service company, a work management system for performing the maintenance service efficiently is operated by connecting a call center system and a plurality of work base systems by the Intranet.

The call center is a center that collectively receives failure calls and failure inquiries from users (customers). The work base system is a system that issues instructions to a maintenance worker who visits the user's place to remove the failure, in response to the instruction from the call center to handle the failure.

However, the maintenance service is expanding, and if the maintenance service is often assigned to a subcontractor, it becomes necessary to introduce the work base system to the subcontractor and connect it with the call center system via the Internet.

Japanese Patent Application Laid-Open No. 2001-331596 discloses a work management system in which the call center system and the work base system are connected by the Internet, and the data communication therebetween is carried out via an electronic mail.

In the conventional work management system, since the call center system and the work base systems are only connected via the Internet, when a maintenance worker is sent to the user, it becomes a one-sided request for securing personnel from the call center to the work base system. Therefore, there is a problem in that labor shortage occurs in the busy period, and smooth temporary staffing cannot be carried out.

### SUMMARY OF THE INVENTION

According to the present invention, a request that indicates willingness of a user to receive a service is received from the user, and an advertisement is performed for recruiting a service person based on the service request. The service persons who have applied for the post of the service person are authenticated, and an authentic service person is dispatched to the user to provide the service.

These and other objects, features and advantages of the present invention are specifically set forth in or will become apparent from the following detailed descriptions of the invention when read in conjunction with the accompanying drawings.

### BRIEF DESCRIPTION OF THE DRAWINGS

FIG. 1 is a block diagram that shows the configuration of one embodiment according to the present invention;

FIG. 2 show a table structure of a user information database 320 shown in FIG. 1;

FIG. 3 show a table structure of a service request information database 330 shown in FIG. 1;

FIG. 4 show a table structure of a servicing staff information database 340 shown in FIG. 1;

FIG. 5 shows a table structure of a service charge information database 350 shown in FIG. 1;

FIG. 6 shows a table structure of a service providing company information database 360 shown in FIG. 1;

FIG. 7 is a block diagram that shows the configuration of a portable terminal 500₁ carried by a servicing staff shown in FIG. 1;

FIG. 8 is a sequence diagram that explains the outline of the operation in the embodiment;

FIG. 9 is a flowchart that explains the operation of a service operation management apparatus 300 shown in FIG. 1;

FIG. 10 shows screens in the service operation management apparatus 300 shown in FIG. 1;

FIG. 11 shows a service request reception screen 600 shown in FIG. 10;

FIG. 12 shows a servicing staff recruitment screen 610 shown in FIG. 10;

FIG. 13 shows a service progress screen 620 shown in FIG. 10;

FIG. 14 shows a service charge billing confirmation screen 630 shown in FIG. 10;

FIG. 15 shows service charge payment confirmation screen 640 shown in FIG. 10;

FIG. 16 shows a servicing staff recruitment screen 700 displayed on servicing staff portable terminals 500₁ to 500ₘ shown in FIG. 1;

FIG. 17 shows a servicing staff application screen 710 displayed on the servicing staff portable terminals 500₁ to 500ₘ shown in FIG. 1;

FIG. 18 shows a moving screen 720 displayed on the servicing staff portable terminals 500₁ to 500ₘ shown in FIG. 1;

FIG. 19 shows a servicing screen 730 displayed on the servicing staff portable terminals 500₁ to 500ₘ shown in FIG. 1;

FIG. 20 shows a service temporary completion screen 740 displayed on the servicing staff portable terminals 500₁ to 500ₘ shown in FIG. 1; and

FIG. 21 shows the configuration of a modified example of the embodiment.

### DETAILED DESCRIPTIONS

Exemplary embodiment of the service operation management program according to the present invention will be explained in detail, with reference to the drawings.

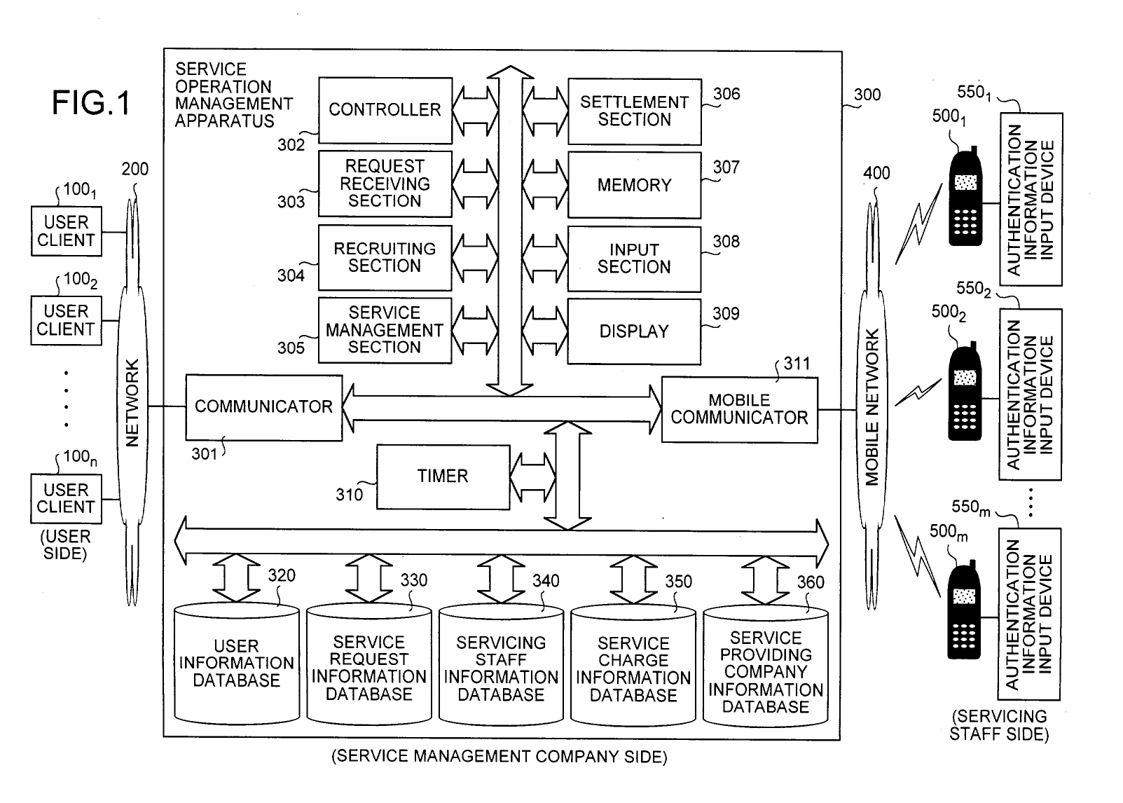

FIG. 1 is a block diagram that shows the configuration of the embodiment according to the present invention. In this figure, a service operation management system for managing the service operation is shown.

The service operation referred to herein means to provide various kinds of services (general services involving supply of labor, such as maintenance service and new installment of equipment) requiring payment for the service charge, from a service management company (a service providing company) to a user (a customer provided with service).

The service operation management system comprises of user clients 100₁ to 100ₙ, a network 200, a service operation management apparatus 300, a mobile network 400, servicing staff portable terminals 500₁ to 500ₘ, and authentication information input devices 550₁ to 550ₘ.

Each of the user clients 100₁ to 100ₙ is a computer terminal provided on the user side, and is connectable to the service operation management apparatus 300 via the network 20.0.

These user clients 100₁ to 100ₙ are operated by users at the time of requesting service. Service request means requesting supply of various kinds of services, from a user to the service management company.

The service operation management apparatus 300 is installed on the service management company side, and is an apparatus that manages reception of service requests, recruiting and assignment of servicing staffs, progress of service, and settlement of service charges, at the time of providing services.

The service operation management apparatus 300 is connectable to the portable terminals 500₁ to 500ₘ carried by the servicing staffs via the mobile network 400. The mobile network 400 is a network comprising a gateway (not shown) and a radio base station (not shown) that supports mobile communication.

Each of the servicing staff portable terminals 500₁ to 500ₘ is carried by a servicing staff who actually provides service to users, and, for example, a PDA (Personal Digital Assistants), a portable phone, a PHS (Personal Handyphone System), a notebook-sized personal computer and the like. The servicing staff belongs to the service providing company.

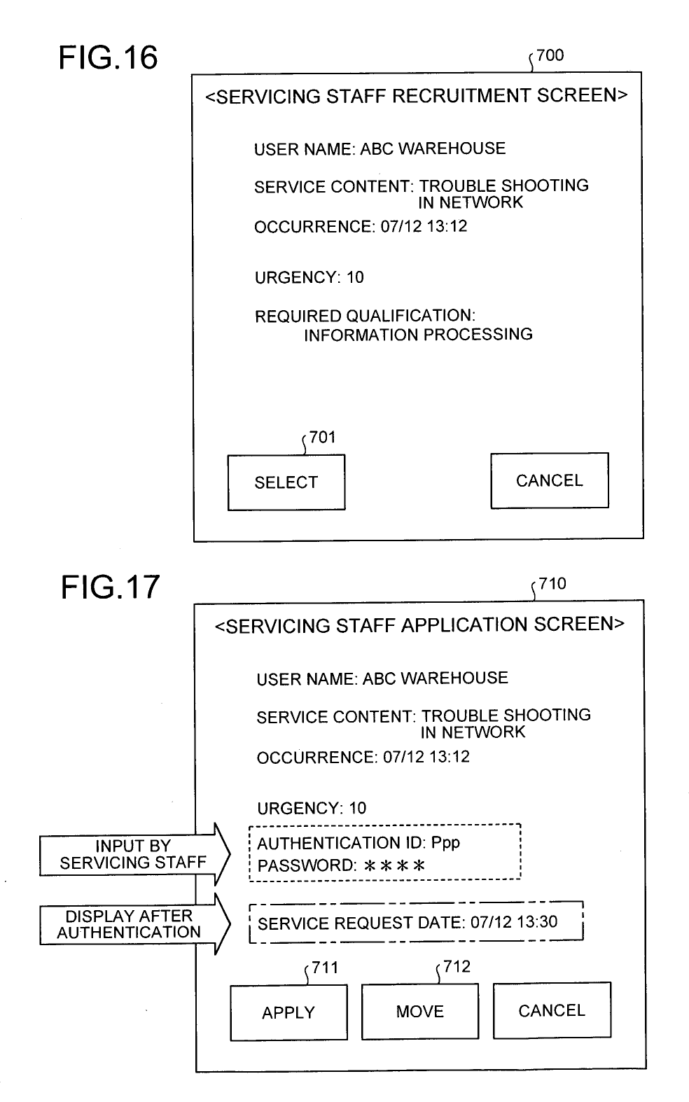

These servicing staff portable terminals 500₁ to 500ₘ have functions of carrying out communication with the service operation management apparatus 300 via a radio link or the mobile network 400, and notifying the service operation management apparatus 300 (service management company) of the progress of service (recruiting of a servicing staff, application of a servicing staff, moving, servicing, temporary completion of service, completion of service), using various screens (see FIG. 16 to FIG. 20) described later.

In the service operation management apparatus 300, a communicator 301 manages communication between user clients 100₁ to 100ₙ and the apparatus 300 via the network 200, in accordance with a predetermined communication protocol.

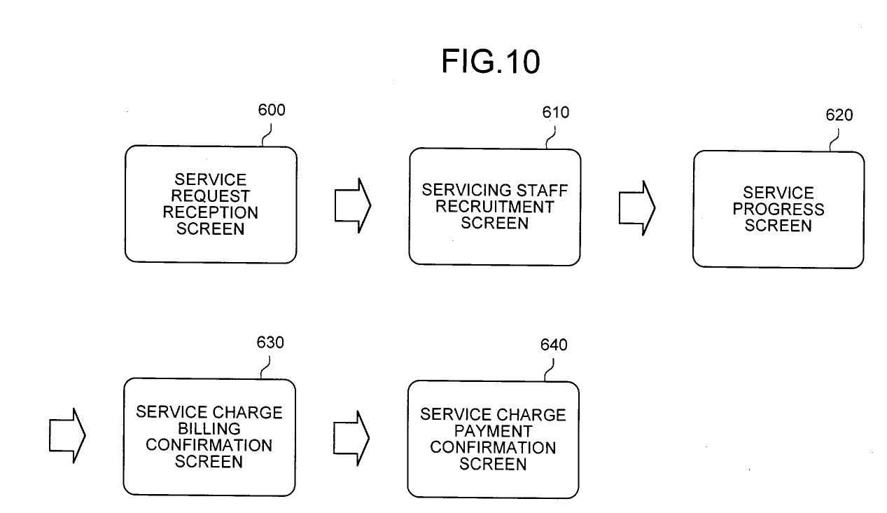

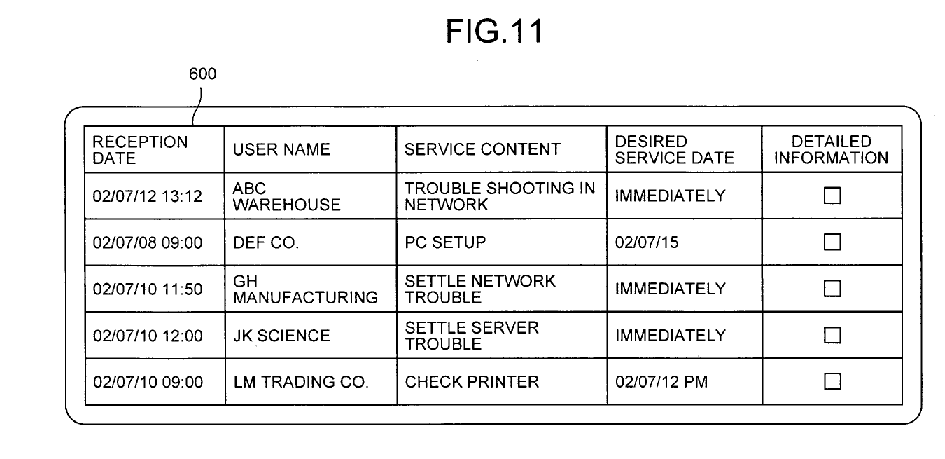

A controller 302 is for controlling each section of the apparatus. A request receiving section 303 has a function of receiving a service request from each of the user clients 100₁ to 100ₙ, using a service request reception screen 600 (see FIG. 10 and FIG. 11) described later.

In the service operation management apparatus 300, as shown in FIG. 10, screens shift in order of the service request reception screen 600, a servicing staff recruitment screen 610, a service progress screen 620, a service charge billing confirmation screen 630, and a service charge payment confirmation screen 640.

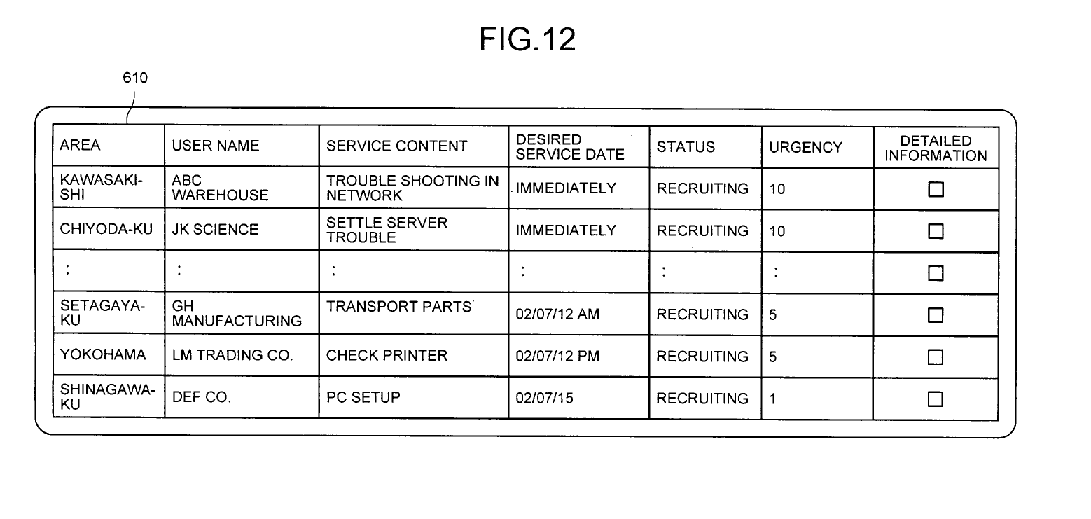

Returning to FIG. 1, a recruiting section 304 has a function of recruiting a servicing staff who actually provides the service, after having received a service request, using the servicing staff recruitment screen 610 (see FIG. 10 and FIG. 12).

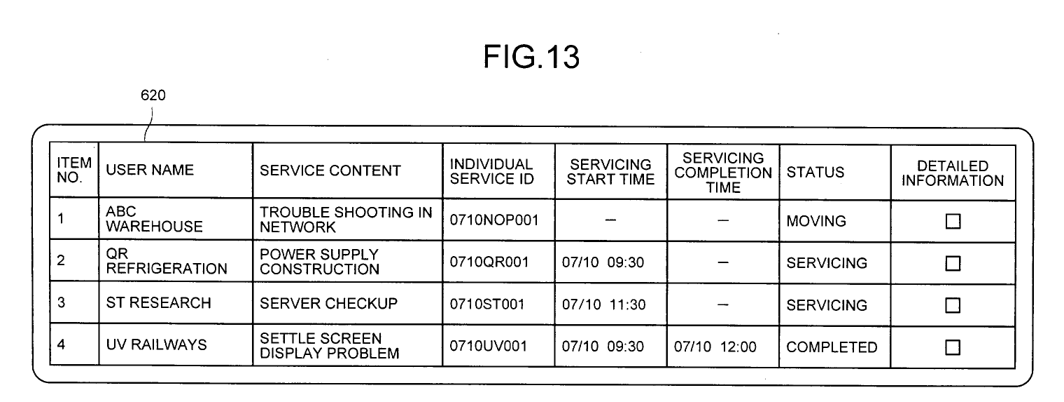

A service management section 305 has a function of managing the progress of the service (recruiting of a servicing staff, application of a servicing staff, moving, and the like), using the service progress screen 620 (see FIG. 10 and FIG. 13).

A settlement section 306 has a function of settling the service charge. Specifically, the settlement section 306 has a function of billing the user for the service charge, and then paying the service charge (the amount obtained by deducting the management fee therefrom) to a service providing company, to which the servicing staff belongs.

Various kinds of information handled in each section are stored in a memory 307. An input section 308 is a keyboard, a mouse and the like. A display 309 is for example a CRT (Cathode Ray Tube) or an LCD (Liquid Crystal Display), and displays various screens (see FIG. 10 to FIG. 15) described later.

A timer 310 has a function of notifying the settlement section 306 of the start time of servicing and the finish time of servicing, at the time of calculating the service charge. The mobile communicator 31 manages communication with the servicing staff portable terminals 500₁ to 500ₘ via the mobile network 400, in accordance with a predetermined communication protocol.

The service operation management apparatus 300 has various databases such as a user information database 320, a service request information database 330, a servicing staff information database 340, a service charge information database 350, and a service providing company information database 360.

The user information database 320 is a database for storing user information relating to users (corresponding to the user clients 100₁ to 100ₙ) who receive servicing.

Specifically, the user information database 320 comprises of fields of “basic information”, “system manager information”, “contract information”, and “accounting information”. The “basic information” comprises “user name” showing user's name, “address”, “phone number”, and “user code” for identifying a user.

The “system manager information” is information relating to a system manager of the user, and comprises “system manager's name” showing the name of the system manager, “system manager's ID” for identifying the system manager, and “authentication ID/password” used for authentication.

The “contract information” is information relating to contracts made between the service providing company and users for servicing, and comprises “name of person in charge of contract” showing the name of the person in charge of contract, “daytime service” for providing service only in the daytime, “24 hours service” for providing service anytime for 24 hours, and “time service” for providing service at any time as a spot correspondence.

With regard to the “daytime service”, “24 hours service”, and “time service”, when “0” flag is set, it indicates there is no contract, and when “1” flag is set, it indicates there is a contract.

The “accounting information” is information relating to billing and payment of service charges between users and the service management company, and comprises of “user to be billed” and “payment method”.

Returning to FIG. 1, the service request information database 330 is a database for storing service request information relating to a service request from any user client (user) of the user clients 100₁ to 100ₙ to the service operation management apparatus 300 (service management company).

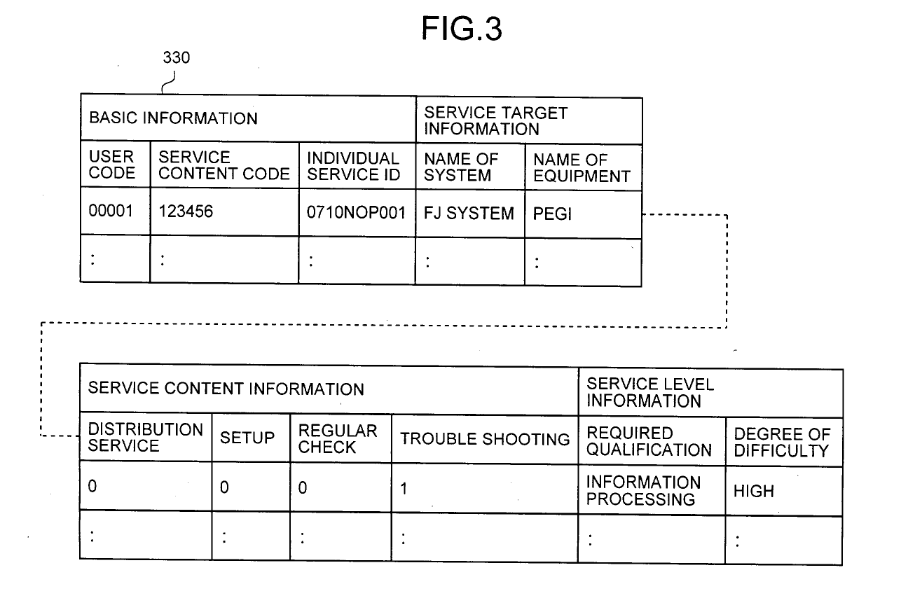

Specifically, the service request information database 330 shown in FIG. 3 comprises fields of “basic information”, “service target information”, “service content information”, and “service level information”.

The “basic information” comprises of “user code” for identifying a user, “service content code” for identifying service contents (“distribution service”, “setup”, “regular check”, and “troubleshooting” in “service content information”), and “individual service ID” for identifying a service corresponding to the service request.

The “service target information” comprises of “name of system” and “name of equipment” that is to receive the service. The “service content information” is information relating to a specific content of the service, and comprises “distribution service” for distributing a service target, “setup” such as installing a computer program in the service target, “regular check” for regularly checking the service target, and “troubleshooting” for settling troubles (faults) that has occurred in the service target.

With regard to these “distribution service”, “setup”, “regular check”, and “troubleshooting”, when “0” flag is set, it indicates that there is no service request, and when “1” flag is set, it indicates that there is a service request.

The “service level information” comprises “required qualification”, and “degree of difficulty” that indicates a level in providing the service. The “required qualification” is information relating to a qualification required for the servicing staff. The “degree of difficulty” is information relating to the difficulty of the “required qualification”.

Returning to FIG. 1, the servicing staff information database 340 is a database for storing the servicing staff information relating to servicing staffs, respectively carrying the servicing staff portable terminals 500₁ to 500ₘ.

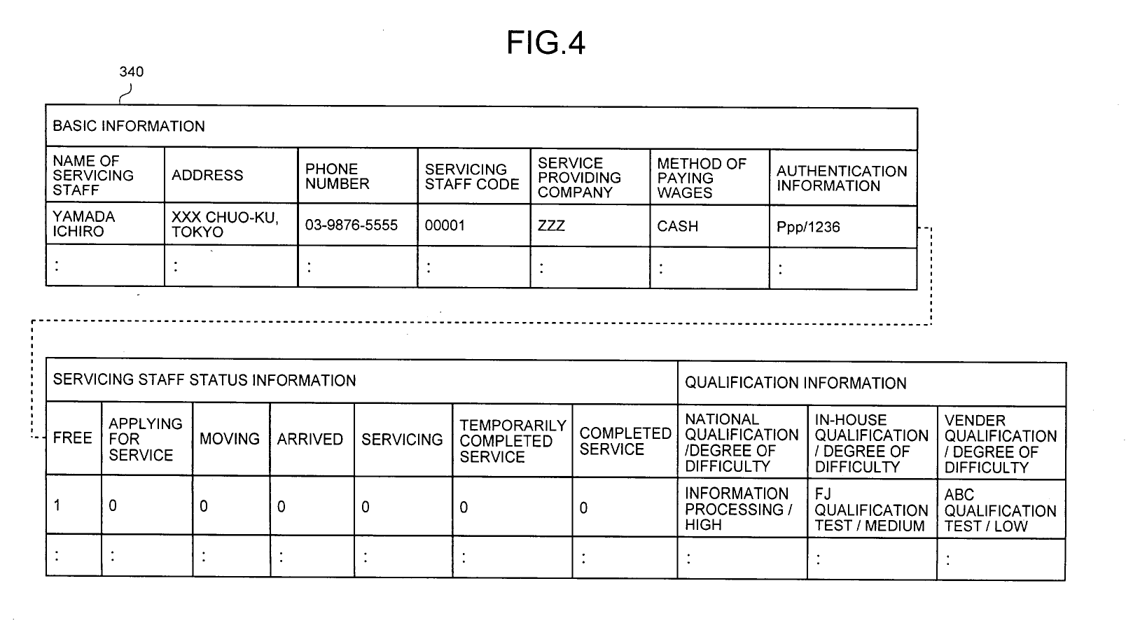

Specifically, the servicing staff information database 340 shown in FIG. 4 comprises “basic information”, “servicing staff status information”, and “qualification information”.

The “basic information” comprises “name of servicing staff” indicating the name of the servicing staff, “address”, “phone number”, “servicing staff code” for identifying the servicing staff, “service providing company” indicating the service providing company to which the servicing staff belongs, “method of paying wages” indicating the payment method of wages to the servicing staff, and “authentication information” for authenticating the servicing staff by the service operation management apparatus 300.

The “authentication information” is information such as authentication ID/password, digital signature, signature handwriting, fingerprint, voiceprint, eye pattern, and finger vein pattern, and may be any information so long as it can specify the servicing staff uniquely.

The information of the digital signature, signature handwriting, fingerprint, voice print, eye pattern, finger vein pattern is used when high-level security level is required, since these are difficult to fake, compared to the authentication ID/password.

In the embodiment, only the servicing staff code, or the servicing staff code/password, the servicing staff code/phone number, or the servicing staff code/network address may be used instead of the authentication ID/password to perform authentication.

The “servicing staff status information” is information showing the status of the servicing staff, and comprises “free”, “applying for service”, “moving”, “arrived”, “servicing”, “temporarily completed service”, and “completed service”. “Free” represents a status that the servicing staff has no work to do at present, and can perform servicing work at any time. “Applying for service” represents a status that the servicing staff is now applying for the recruitment of a servicing staff from the service operation management apparatus 300 (service management company). “Moving” represents a status that the servicing staff is now moving to the user for providing service.

“Arrived” represents a status that the servicing staff has arrived at the user's place. “Servicing” represents a status that the servicing staff is now providing service at the user's place. “Temporarily completed service” represents a status that the service has temporarily been completed. “Completed service” represents a status that the service has been completed.

With regard to these “free”, “applying for service”, “moving”, “arrived”, “servicing”, “temporarily completed service”, and “completed service”, when “0” flag is set, it indicates that the servicing staff is not in the state, and when “1” flag is set, it indicates that the servicing staff is in the state.

The “servicing staff status information” is updated every time when a notification is received from respective servicing staff portable terminals 500₁ to 500ₘ.

The “qualification information” is information showing the qualification which the servicing staff holds and its difficulty, and it includes “national qualification/degree of difficulty”, “in-house qualification/degree of difficulty”, and “vender qualification/degree of difficulty”.

Returning to FIG. 1, the service charge information database 350 is a database for storing service charge information relating to service charges set for respective service contents, to be paid from the user to the service management company, as a consideration for servicing.

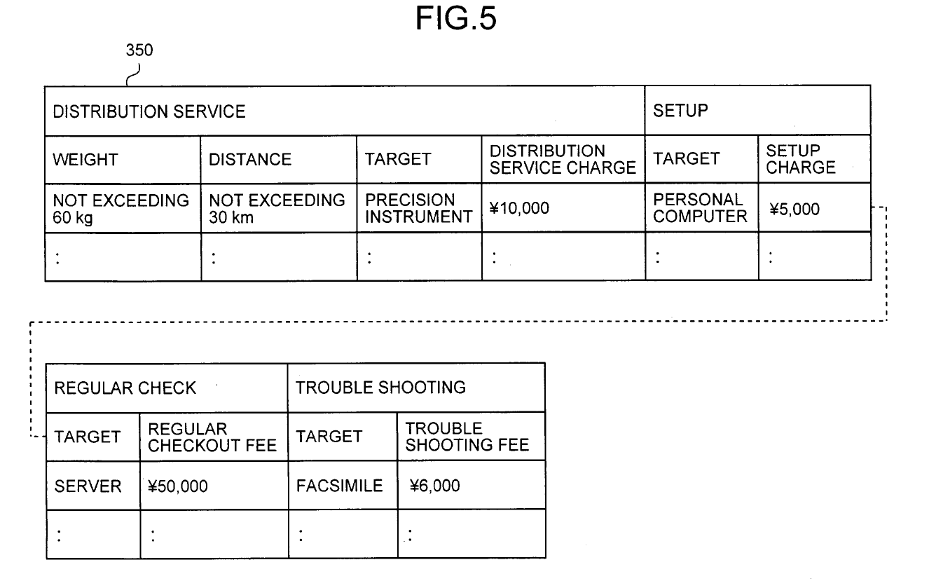

Specifically, the service charge information database 350 shown in FIG. 5 comprises fields of “distribution service”, “setup”, “regular check”, and “trouble shooting”, corresponding to the “service content information” in the service request information database 330 (see FIG. 3).

“Distribution service” is information on service charge relating to the distribution service, and includes “weight”, “distance”, “target”, and “distribution service charge”. “Setup” is information on service charges relating to setup, and includes “target” and “setup charge”.

“Regular check” is information on service charge relating to the regular check, and includes “target” and “regular check fee”. “Trouble shooting” is information on service charge relating to trouble shooting, and includes “target” and “trouble shooting fee”.

Returning to FIG. 1, the service providing company information database 360 is a database for storing information relating to a plurality of service providing companies, to which respective servicing staffs carrying the servicing staff portable terminals 500₁ to 500ₘ belong.

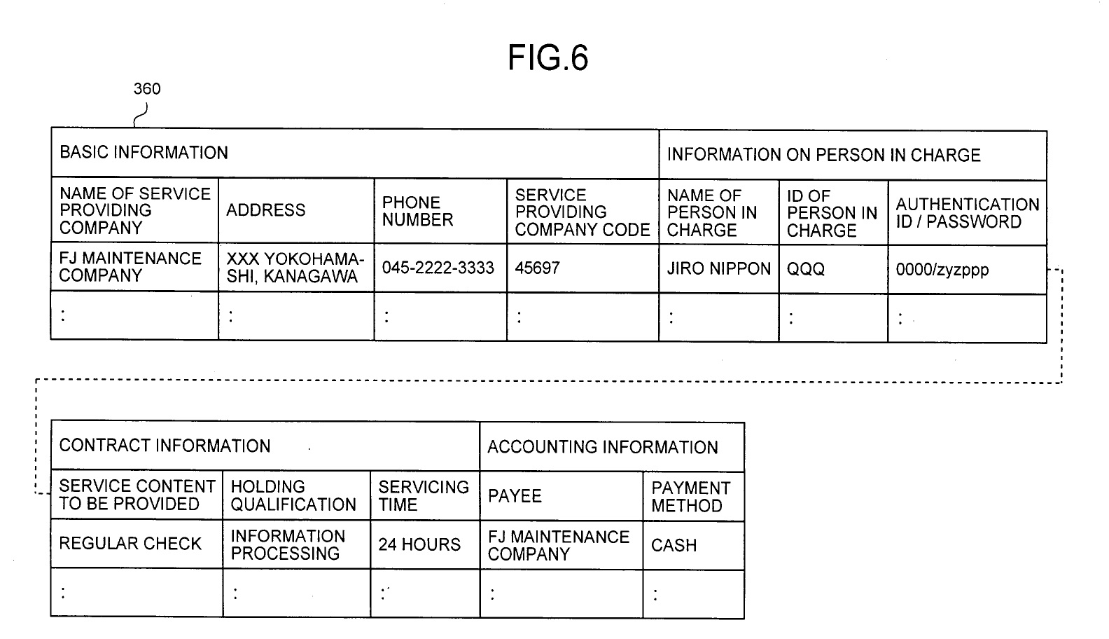

Specifically, the service providing company information database 360 shown in FIG. 6 comprises fields of “basic information”, “information on person in charge”, “contract information” and “accounting information”. The “basic information” comprises “name of service providing company” showing the name of the service providing company, “address”, “phone No.”, and “service providing company code” for identifying the service providing company.

“Information on person in charge” is information relating to a person in charge, serving as a clerk in charge of outside relations in the service providing company, and comprises “name of person in charge” showing the name of person in charge, “ID of person in charge” for identifying the person in charge, and “authentication ID/password” used for authentication.

“Contract information” is information relating to a contract made between the service providing company and the service management company, with regard to servicing, and comprises “service content to be provided”, “holding qualification”, and “servicing time”. “Service content to be provided” shows contents of service that can be provided from the service providing company to the user, and corresponds to the “service content information” in the service request information database 330.(see FIG. 3).

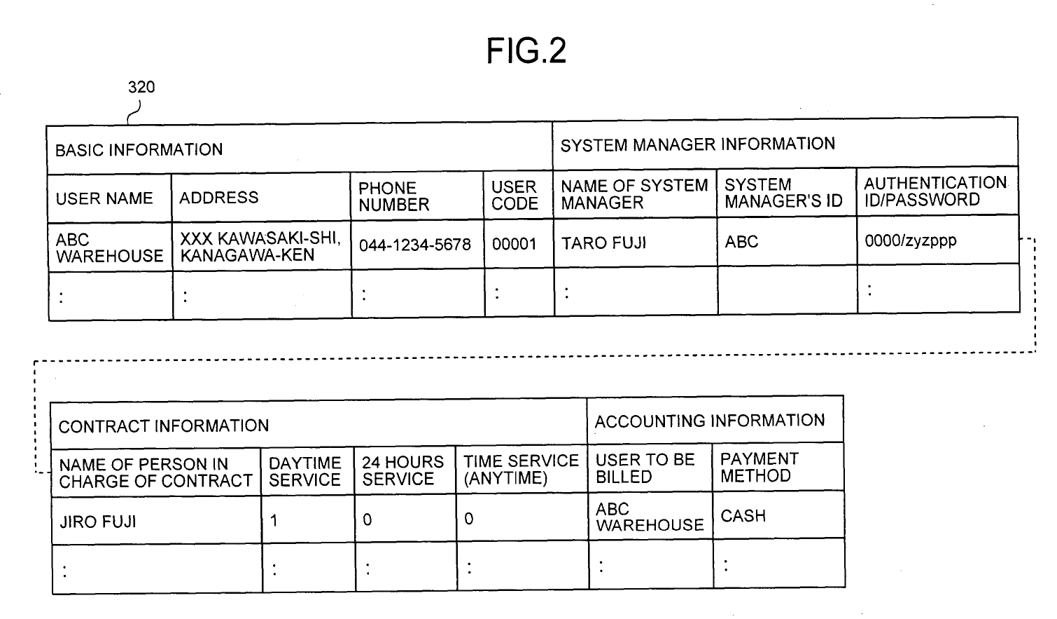

“Holding qualification” is a qualification held by the servicing staff who belongs to the service providing company. “Servicing time” is time during which the service can be provided, and corresponds to “daytime service”, “24 hours service” or “time service (anytime)”, in the user information database 320 (see FIG. 2).

The “accounting information” is information relating to the payee and payment method of service charges from the service management company to the service providing company, and comprises “payee” and “payment method”.

Returning to FIG. 1, each of the authentication information input devices 550₁ to 550ₘ is connected to each of the servicing staff portable terminals 500₁ to 500ₘ, as required. These authentication information input devices 550₁ to 550ₘ are devices for inputting the “authentication information” (digital signature, signature handwriting, fingerprint, voice print, eye pattern, finger vein pattern, etc.) for authenticating the servicing staff by the service operation management apparatus 300 (digital signing device, tablet/ultrasonic pen, fingerprint identifier, voice print identifier, eye pattern identifier and finger vein pattern identifier). The authentication ID/password as the “authentication information” is input from the input section of the respective servicing staff portable terminals.

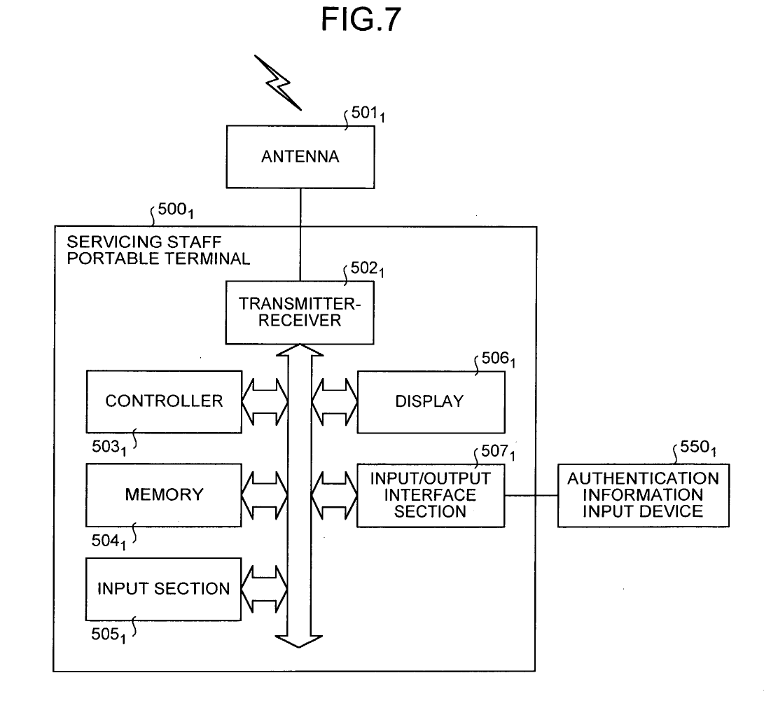

FIG. 7 is a block diagram that shows the configuration of the servicing staff portable terminal 500₁ shown in FIG. 1. In this figure, a transmitter-receiver 502₁ transmits and receives various kinds of information to/from the service operation management apparatus 300 via an antenna 501₁, a radio link, and the mobile network 400.

A controller 503₁ controls respective sections. A memory 504₁ stores farmware to be executed in the controller 503₁ and various kinds of information. An input section 505₁ is alphanumeric keys and function keys, and is used for inputting the authentication ID/password as the “authentication information” or the like.

A display 506₁ is an LCD for displaying various screens (see FIG. 16 to FIG. 20) described later. An input/output interface section 507₁ is connected with the authentication information input device 550₁. Servicing staff portable terminals 500₂ to 500ₘ shown in FIG. 1 have the same configuration as that of the servicing staff portable terminals 500₁ shown in FIG. 7.

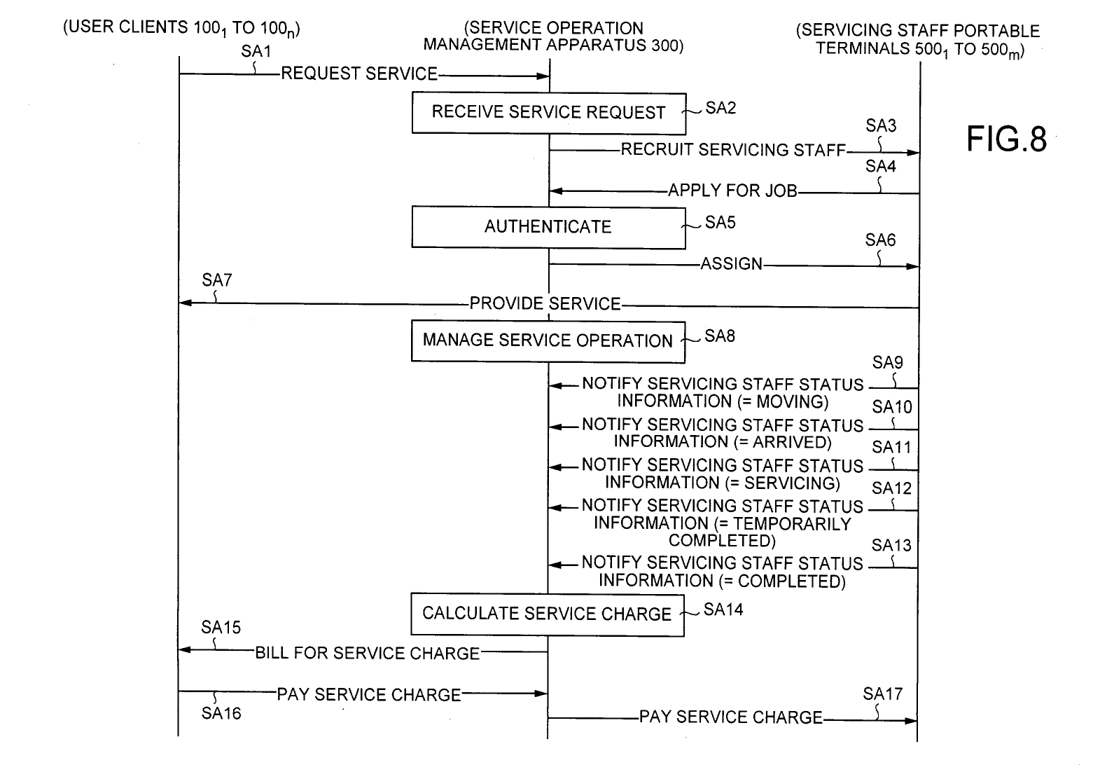

The outline of the operation in the embodiment will be explained, with reference to the sequence diagram shown in FIG. 8. At step SA1 shown in FIG. 8, for example, a user client 100₁ issues a service request to the service operation management apparatus 300 via the network 200.

At step SA2, the service operation management apparatus 300 receives the service request, using the service request reception screen 600 (see FIG. 11). At step SA3, the service operation management apparatus 300 performs recruiting of a servicing staff with respect to the servicing staff portable terminals 500₁ to 500ₘ, corresponding to the service request, by using the servicing staff recruitment screen 610 (see FIG. 12). The servicing staff recruitment screen 700 (see FIG. 16) is displayed on each display of the servicing staff portable terminals 500₁ to 500ₘ.

At step SA4, for example, the servicing staff portable terminal 500₁ applies for the job of the servicing staff, using the servicing staff application screen 710 (see FIG. 17), corresponding to the recruitment of the servicing staff. At step SA5, the service operation management apparatus 300 performs authentication based on the authentication information from the servicing staff portable terminal 5001.

At step SA6, the service operation management apparatus 300 accesses the servicing staff portable terminal 500₁ via the mobile network 400, in order to assign the authenticated servicing staff.

At step SA7, the assigned servicing staff starts to provide service to the user corresponding to the user client 100₁. At step SA8, the service operation management apparatus 300 manages the service, using the service progress screen 620 (see FIG. 13).

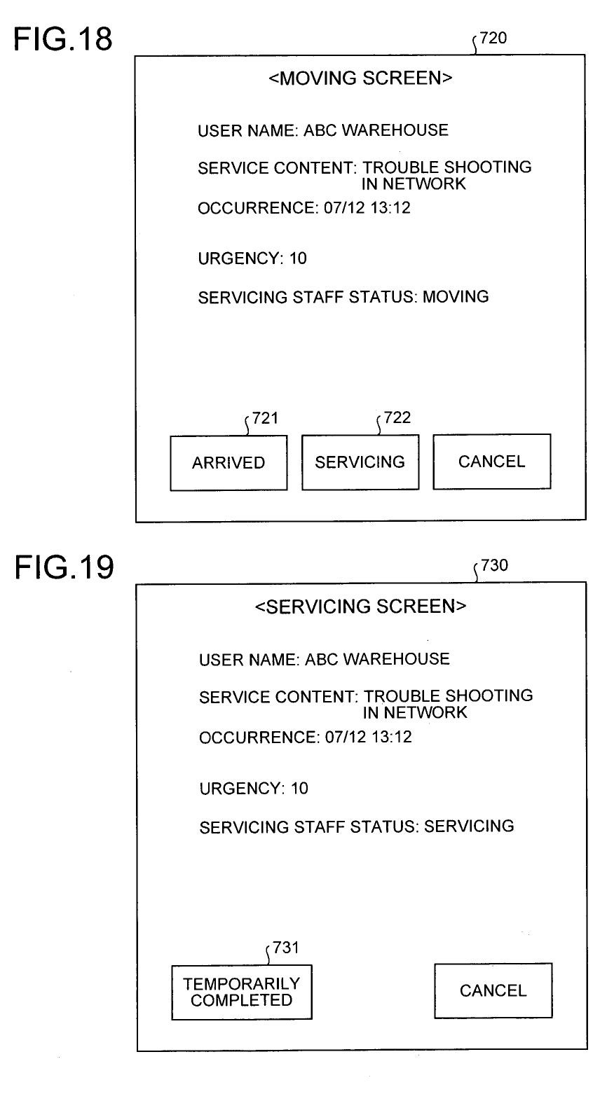

At step SA9, the servicing staff portable terminal 500₁ notifies the service operation management apparatus 300 of the servicing staff status information (=moving), representing that the servicing staff is moving to the user's place. At step SA10, the servicing staff portable terminal 500₁ notifies the service operation management apparatus 300 of the servicing staff status information (=arrival), when an arrival button 721 on the moving screen 720 (see FIG. 18) is pressed.

At step SA11, the servicing staff portable terminal 500₁ notifies the service operation management apparatus 300 of the servicing staff status information (=servicing), when the servicing staff has started to provide service at the user's place.

At step SA12, the servicing staff portable terminal 500₁ notifies the service operation management apparatus 300 of the servicing staff status information (=temporary completion), when a temporary completion button 731 on a service providing screen 730 (see FIG. 19) is pressed.

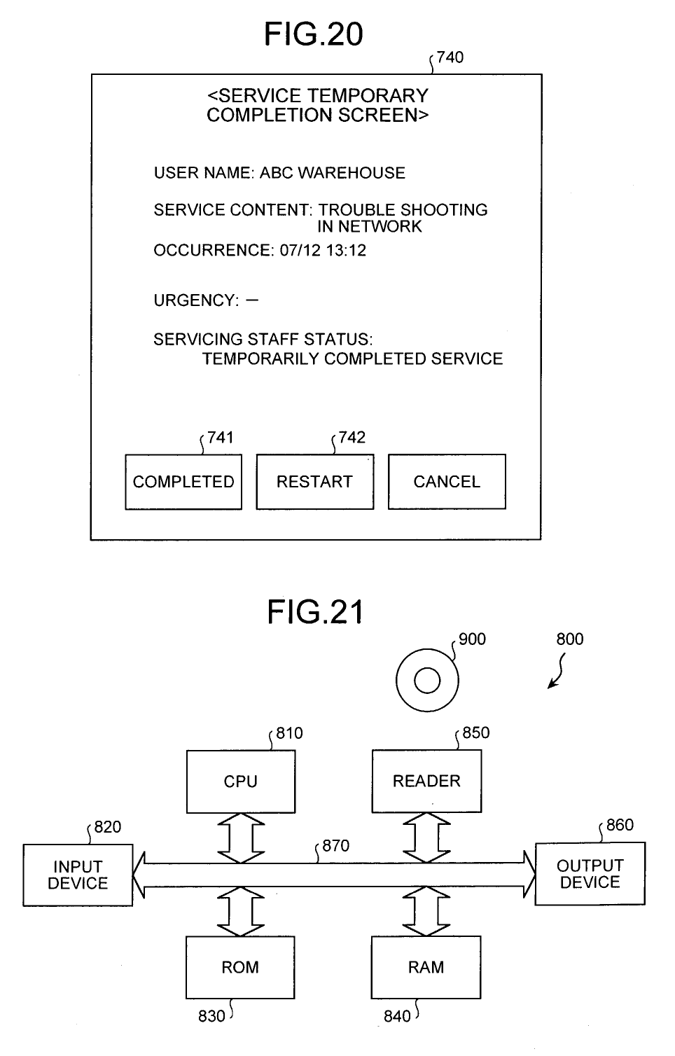

At step SA13, the servicing staff portable terminal 500₁ notifies the service operation management apparatus 300 of the servicing staff status information (=completion), when a completion button 741 on a service temporary completion screen 740 (see FIG. 20) is pressed. A re-start button 742 is pressed when servicing is once suspended and then re-started.

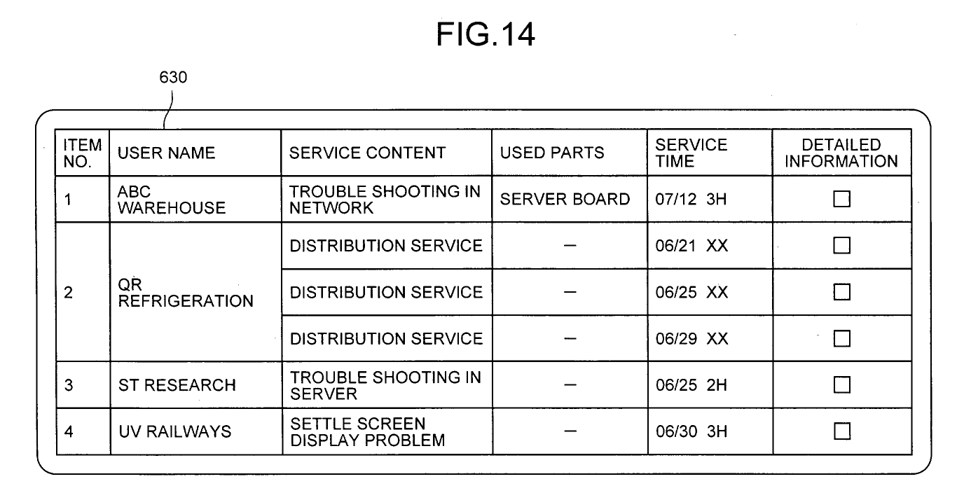

At step SA14, the service operation management apparatus 300 calculates service charge for the service, based on the service charge information database 350 (see FIG. 5). At step SA15, the service operation management apparatus 300 uses the service charge billing confirmation screen 630 (see FIG. 14), to execute the processing for billing the user for the service charge.

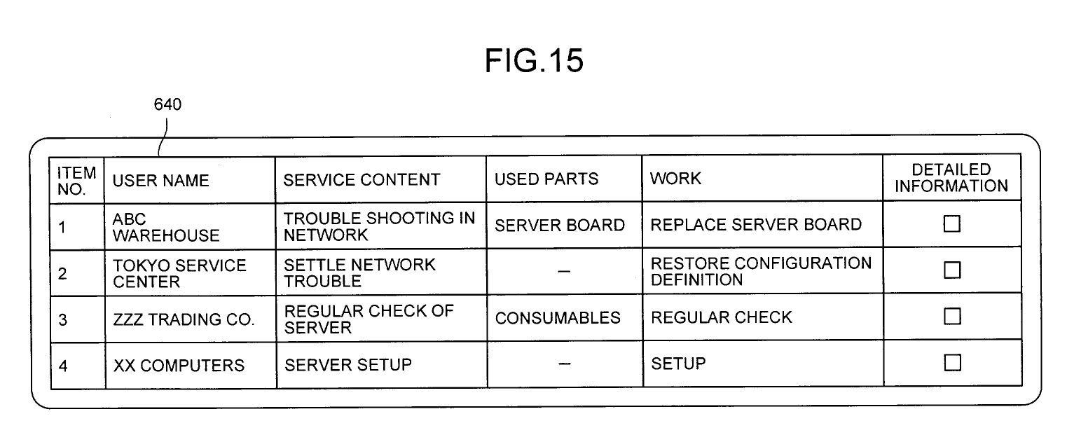

At step SA16, the service charge is paid from the user to the service management company. At step SA17, the service operation management apparatus 300 uses the service charge payment confirmation screen 640 (see FIG. 15), to execute the processing for paying the service charge from the service management company to the service providing company.

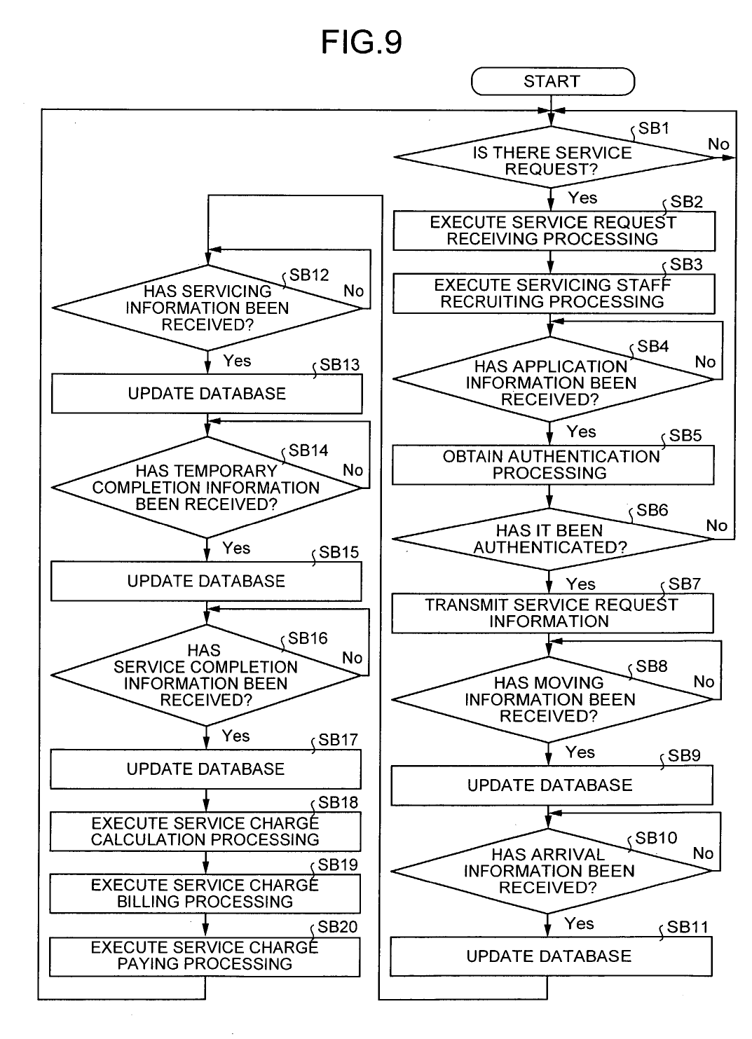

The detailed operation in the embodiment will be explained, with reference to the flowchart shown in FIG. 9. FIG. 9 is a flowchart that explains the operation of the service operation management apparatus 300 shown in FIG. 1.

A specific example will be explained, in which a user (=ABC Warehouse) corresponding to the user client 100₁ receives predetermined servicing (trouble shooting in the network).

At step SB1 shown in FIG. 9, a request receiving section 303 in the service operation management apparatus 300 judges whether there is a service request from any one of the user clients 100₁ to 100ₙ, and in this case, it judges “No”, and repeats the judgment.

When there is a service request (trouble shooting in the network) from the user clients 100₁ (ABC Warehouse) via the network 200, the request receiving section 303 judges “Yes” at step SB1.

At step SB2, the request receiving section 303 executes the service request receiving processing for receiving the service request from the user clients 100₁.

In this case, the request receiving section 303 obtains “reception date” (=02/07/12 13:12), “user name” (=ABC Warehouse), “service content” (=trouble shooting in the network), “desired date for the service” (=immediately), and “detailed information”, on the service request reception screen 600 shown in FIG. 11.

The “detailed information” is user information in the user information database 320 shown in FIG. 2. The “individual service ID” (=0710NOP001) in the “detailed information” is automatically numbered. The request receiving section 303 allows the display 309 to display the service request reception screen 600.

At step SB3, a recruiting section 304 searches a “free” servicing staff information from the servicing staff information database 340 shown in FIG. 4, using the “required qualification” (see FIG. 3) in the “detailed information” obtained at step SB2 as a key.

In other words, the recruiting section 304 picks up a servicing staff having a skill (qualification) sufficient for the service request, and also being “free”, as a target to be recruited as the servicing staff.

The recruiting section 304 then transmits the servicing staff recruiting information corresponding to the servicing staff recruitment screen 700 shown in FIG. 16 to the servicing staff portable terminal (included in the servicing staff portable terminals 500₁ to 500ₘ) carried by the searched servicing staff, via the mobile network 400.

The recruiting section 304 also allows the display 309 to display the servicing staff recruitment screen 610 shown in FIG. 12. On the servicing staff recruitment screen 610 are displayed “area”, “user name”, “service content”, “desired date for the service”, “status”, “urgency”, and “detailed information”.

The “detailed information” is user information (required qualification) in the user information database 320 shown in FIG. 2, and service request information in the service request information database 330 shown in FIG. 3.

At step SB4, the recruiting section 304 judges whether the application information corresponding to the servicing staff recruitment has been received from the servicing staff portable terminals, and in this case, it judges “No”, and repeats the judgment.

When the servicing staff recruiting information is received by, for example, the servicing staff portable terminal 500₁ the servicing staff recruitment screen 700 shown in FIG. 16 is displayed on the display 506₁ (see FIG. 7) of the servicing staff portable terminal 500₁.

On the servicing staff recruitment screen 700 are displayed information on “user name” (=ABC Warehouse) who has issued the service request, “service content” (=trouble shooting in the network), “occurrence” (=07/02 13:12), “urgency” (=10), and “required qualification” (=information processing).

A free servicing staff checks whether he/she can provide the service, using the servicing staff recruitment screen 700, and if he/she meets the requirement in the “required qualification”, he/she presses a selection button 701.

Thereby, the controller 503, in the servicing staff portable terminal 5001 allows the display 506, to display the servicing staff application screen 710 shown in FIG. 17. On this servicing staff application screen 710, the “service name”, . . . , and “urgency” are displayed. At this time., “authentication ID”, “password”, and “service requested date” are not displayed.

When applying for the servicing staff job, the servicing staff inputs the “authentication ID” and “password” as the authentication information from the input section 5051, and presses an apply button 711. Thereby, the application information (“authentication ID” and “password” are included) corresponding to the servicing staff application screen 710 is transmitted to the service operation management apparatus 300 from the servicing staff portable terminal 5001.

When the application information has been received by the service operation management apparatus 300, the recruiting section 304 judges “Yes” at step SB4. At step SB5, the recruiting section 304 obtains the authentication information (“authentication ID” and “password”) from the application information, and performs authentication processing whether the servicing staff is the right person, by comparing the authentication information with the “authentication information” stored in the servicing staff information database 340.

When the both information agree with each other, it means that the servicing staff is authenticated, and the recruiting section 304 judges “Yes” at step SB6. On the other hand, if the both information do not agree with each other, it means that the servicing staff is not authenticated, and the recruiting section 304 judges “No” at step SB6, and performs judgment at step SB1.

When the “authentication information” is information other than the “authentication ID” and “password” (that is, digital signature, signature handwriting, fingerprint, voice print, eye pattern, finger vein pattern, etc.), the information is input from the authentication information input device 550₁. Authentication is then performed based on the comparison result of the information with the authentication information stored in the servicing staff information database 340 (digital signature, signature handwriting, finger print, voice print, eye pattern, finger vein pattern, etc.).

The recruiting section 304 sets “1” flag in the column of “applying for the service” in the “servicing staff status information” in the servicing staff information database 340 shown in FIG. 4.

If it is assumed that the judgment result at step SB6 for authentication is “Yes”, at step SB7, the recruiting section 304 transmits the service request information (including service request time) for assigning the servicing staff to the servicing staff portable terminal 5001. The service management section 305 manages the progress of the service on the service progress screen 620 shown in FIG. 13.

On this service progress screen 620, “item number”, “user name”, “service content”, “individual service ID”, “servicing start time”, “servicing completion time”, “status”, and “detailed information” are displayed.

The “detailed information” is user information in the user information database 320 shown in FIG. 2, the service request information in the service request information database 330 shown in FIG. 3, and the servicing staff information (qualification information) in the servicing staff information database 340 shown in FIG. 4.

At step SB8, the service management section 305 judges whether the moving information has been received from the servicing staff portable terminal 500₁, and in this case, it judges “No”, and repeats the judgment.

When the service request information is received by the servicing staff portable terminal 500₁, the controller 503₁ displays the service request date on the servicing staff application screen 710 shown in FIG. 17. Thereby, servicing is officially assigned to the servicing staff.

When the servicing staff starts to move to the user's place, the servicing staff presses a move button 712 on the servicing staff application screen 710. Thereby, the moving information indicating that the status of the servicing staff is now moving, is transmitted to the service operation management apparatus 300 from the servicing staff portable terminal 500₁. The moving screen 720 shown in FIG. 18 is displayed on the display 506₁ of the servicing staff portable terminal 500₁.

When the moving information from the servicing staff portable terminal 500₁ is received by the service operation management apparatus 300, the service management section 305 judges “Yes” at step SB8.

At step SB9, the service management section 305 sets “1” flag in the column “moving” in the “servicing staff status information” in the servicing staff information database 340 (see FIG. 4) to update the servicing staff status information, and displays “moving” in the “status” column on the service progress screen 620 (see FIG. 13).

At step SB10, the service management section 305 judges if the arrival information has been received from the servicing staff portable terminal 5001, and in this case, it judges “No”, and repeats the judgment.

When the servicing staff arrives at the user's place, the servicing staff presses an arrival button 721 on the moving screen 720 (see FIG. 18). Thereby, the arrival information indicating that the servicing staff has arrived is transmitted from the servicing staff portable terminal 500₁ to the service operation management apparatus 300.

When the service operation management apparatus 300 receives the arrival information from the servicing staff portable terminal 5001, the service management section 305 judges “Yes” at step SB10.

At step SB11, the service management section 305 sets “1” flag in the column of “arrival” in the “servicing staff status information” in the servicing staff information database 340 (see FIG. 4), and updates the servicing staff status information, and displays “arrival” in the column of “status” on the service progress screen 620 (see FIG. 13).

When having started servicing, the servicing staff presses a servicing button 722 on the moving screen 720 (see FIG. 18). Thereby, the servicing information indicating that the servicing staff is now servicing is transmitted from the servicing staff portable terminal 500₁ to the service operation management apparatus 300. On the display 506₁ on the servicing staff portable terminal 500₁ the servicing screen 730 shown in FIG. 19 is displayed.

At step SB12, the service management section 305 judges if the servicing information has been received from the servicing staff portable terminal 500₁, and in this case, it judges “No”, and repeats the judgment.

When the servicing information from the servicing staff portable terminal 500₁ is received by the service operation management apparatus 300, the service management section 305 judges “Yes” at step SB12. At this time, the settlement section 306 obtains the servicing start time information from the timer 310.

At step SB13, the service management section 305 sets “1” flag in the column of “servicing” in the “servicing staff status information” in the servicing staff information database 340 (see FIG. 4), and updates the servicing staff status information, and displays the date and time when he/she has started servicing in the column of “servicing start time” and “servicing” in the column of “status”, on the service progress screen 620 (see FIG. 13).

At step SB14, the service management section 305 judges if the service temporary completion information has been received from the servicing staff portable terminal 500₁, and in this case, it judges “No”, and repeats the judgment.

When the service has been temporarily completed, the servicing staff presses a temporary completion button 731 on the servicing screen 730 (see FIG. 19). Thereby, the service temporary completion information indicating that the servicing staff has temporarily completed the service is transmitted from the servicing staff portable terminal 500₁ to the service operation management apparatus 300. A service temporary completion screen 740 shown in FIG. 20 is displayed on the display 506, of the servicing staff portable terminal 500₁.

When the service temporary completion information from the servicing staff portable terminal 500₁ is received by the service operation management apparatus 300, the service management section 305 judges “Yes” at step SB14.

At step SB15, the service management section 305 sets “1” flag in the column of “service temporary completion” in the “servicing staff status information” in the servicing staff information database 340 (see FIG. 4), and updates the servicing staff status information, and displays “service temporary completion” in the column of “status” on the service progress screen 620 (see FIG. 13).

At step SB16, the service management section 305 judges if the service completion information has been received from the servicing staff portable terminal 500₁, and in this case, it judges “No”, and repeats the judgment.

When the service has been completed, the servicing staff presses a completion button 741 on the service temporary completion screen 740 (see FIG. 20). Thereby, the service completion information indicating that the servicing staff has completed the service is transmitted from the servicing staff portable terminal 500, to the service operation management apparatus 300.

When the service completion information from the servicing staff portable terminal 500₁ is received by the service operation management apparatus 300, the service management section 305 judges “Yes” at step SB16. At this time, the settlement section 306 obtains the service completion time information from the timer 310.

At step SB17, the service management section 305 sets “1” flag in the column of “service completion” in the “servicing staff status information” in the servicing staff information database 340 (see FIG. 4), and updates the servicing staff status information, and displays the date and time when the service has been completed in the column of “service completion time” and “service completion” in the column of “status”, on the service progress screen 620 (see FIG. 13).

At step SB18, the settlement section 306 refers to the service charge information database 350 (see FIG. 5) to calculate the service charge to be billed to the user (=ABC Warehouse). The settlement section 306 also calculates the servicing time from the servicing start time information and the servicing completion time information. In the embodiment, the service charge may be calculated by the system according to weight based on the servicing time.

At step SB19, the settlement section 306 allows the display 309 to display the service charge billing confirmation screen 630 (see FIG. 14), and bills the user client 100₁ for the service charge. On the service charge billing confirmation screen 630, “item number”, “user name”, “service content”, “used parts”, “servicing time”, and “detailed information” are displayed.

The “detailed information” is the user information (contract information) in the user information database 320 shown in FIG. 2, and the service charge information in the service charge information database 350 shown in FIG. 5.

When the service charge is paid from the user (=ABC Warehouse) to the service management company, at step SB20, the settlement section 306 executes the processing for paying the service charge from the service management company to the service providing company, using the service charge payment confirmation screen 640 (see FIG. 15). Thereby, a series of processing finishes, and judgment at step SB1 is carried out.

On the service charge payment confirmation screen 640, “item number”, “user name”, “used parts”, “work”, and “detailed information” are displayed. The “detailed information” is the service company information (contract information, accounting information) in the service providing company information database 360 shown in FIG. 6, the service charge information in the service charge information database 350 shown in FIG. 5, and the basic information in the servicing staff information database 340 shown in FIG. 4.

In the embodiment, recruiting may be performed with respect to all of a plurality of servicing staffs by a broadcast method.

Further, in the embodiment, recruiting may be performed with respect to servicing staffs selected beforehand, of the servicing staffs, by a multicast method.

In the embodiment, contents of the respective screens shown in FIG. 16 to FIG. 20 and the display order may be freely customized.

As explained above, according to the embodiment, servicing staffs are recruited via the servicing staff portable terminals 500₁ to 500ₘ, in response to the service request from the user clients 100₁ to 100ₙ (users), and after authentication of the applied servicing staff, the authenticated servicing staff is dispatched to the user. Therefore, securement of servicing staffs in a busy period becomes easy, and even in a busy period, smooth temporary staffing with respect to users becomes possible. Further, servicing staffs who are visiting customers can be directly secured in real time, and as a result, smooth temporary staffing becomes possible.

According to the embodiment, the recruiting section 304 performs authentication based on a comparison between the authentication information registered beforehand and the authentication information input by the servicing staff, and hence smooth temporary staffing is made possible, while ensuring security.

According to the embodiment, the service management section 305 receives the state of the servicing staff and status information representing progress of the service (moving, arrived, servicing, temporarily completed the service, and completed the service) in detail from the portable terminal carried by the servicing staff dispatched to the user, and performs progress management. Therefore, the service operation can be apprehended in real time, and smooth temporary staffing becomes possible.

According to the embodiment, since the settlement section 306 carries out processing relating to billing the user for the service charge after completion of the service, and payment for the service charge to the service providing company (servicing staff), smooth accounting processing can be also performed.

One embodiment of the present invention has been explained in detail with reference to the drawings. However, specific configuration examples are not limited to this one embodiment, and various design changes without departing from the scope of the present invention are also included in the present invention.

For example, in the embodiment, a program for realizing the function of the service operation management apparatus 300 may be recorded on a computer readable recording medium 900 shown in FIG. 21, and the program recorded on the recording medium 900 may be read by the computer 800 shown in FIG. 21, and executed to thereby realize each function.

The computer 800 shown in this figure comprises a CPU (Central Processing Unit) 810 that executes the program, an input device 820 such as a keyboard and a mouse, a ROM (Read Only Memory) 830 for storing various data, a RAM (Random Access Memory) 840 for storing calculation parameters and the like, a reader 850 that reads the program from the recording medium 900, an output device 860 such as a display and a printer, and a bus 870 for connecting each section of the apparatus.

The CPU 810 reads the program stored on the recording medium 900 via the reader 850, and executes the program, to thereby realize the functions. The recording medium 900 includes an optical disk, a flexible disk and a hard disk.

According to the present invention, a servicing staff is recruited in response to a service request from a user, and after the applied servicing staff has been authenticated, the authenticated servicing staff is dispatched to the user. Therefore, securement of servicing staff in the busy period becomes easy, and there is the effect that smooth temporary staffing to a user can be performed, even in a busy period.

According to the present invention, recruiting is carried out by transmitting recruiting information to a portable terminal carried by a plurality of servicing staffs. Therefore, servicing staffs who are visiting customers can be directly secured in real time; thereby exhibiting the effect that smooth temporary staffing becomes possible.

According to the present invention, authentication is carried out based on a comparison between authentication information registered in advance and authentication information input by the servicing staff. As a result, there is the effect that smooth temporary staffing becomes possible, while securing security.

According to the present invention, the state of the servicing staff and status information representing progress of the service are received in detail from the portable terminal carried by the servicing staff dispatched to the user, to perform progress management. As a result, there is the effect that the service operation can be apprehended in real time, and smooth temporary staffing becomes possible.

According to the present invention, processing relating to billing the user for the service charge is executed after the completion of the service. As a result, there is the effect that smooth accounting processing can be also performed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A service operation management program that allows a computer to function as:
a service request receiving unit that receives a service request from a user, wherein the service request indicates willingness of the user to receive a service,
a recruiting unit that advertises for recruiting a service person based on the received service request;
an authenticating unit that performs authentication of service persons who have applied for the post of the service person; and
a dispatching unit that dispatches a service person authenticated by the authenticating unit to the user.

2. The service operation management program according to claim 1, wherein the recruiting unit performs the advertisement by transmitting recruiting information to a portable terminal carried by each of a plurality of service persons.

3. The service operation management program according to claim 2, wherein the recruiting unit performs the advertisement with respect to all of the service persons by a broadcast method.

4. The service operation management program according to claim 2, wherein the recruiting unit performs the advertisement with respect to selected service persons by a multicast method.

5. The service operation management program according to claim 1, wherein the authenticating unit carries out the authentication based on a comparison between authentication information registered in advance and authentication information input by the service person in response to the advertisement.

6. The service operation management program according to claim 2, further allows the computer to function as a progress management unit that receives a state of the service person and status information representing progress of the service in detail from the portable terminal carried by the service person dispatched to the user, to thereby perform progress management.

7. The service operation management program according to claim 5, further allows the computer to function as a progress management unit that receives a state of the service person and status information representing progress of the service in detail from the portable terminal carried by the service person dispatched to the user, to thereby perform progress management.

8. The service operation management program according to claim 6, wherein the progress management unit receives the status information transmitted from the portable terminal, according to a menu selection method by the service person.

9. The service operation management program according to claim 7, wherein the progress management unit receives the status information transmitted from the portable terminal, according to a menu selection method by the service person.

10. The service operation management program according to claim 6, wherein the progress management unit receives information relating to the content of the service provided by the service person, from the portable terminal.

11. The service operation management program according to claim 7, wherein the progress management unit receives information relating to the content of the service provided by the service person, from the portable terminal.

12. The service operation management program according to claim 1, further allows the computer to function as a billing unit that executes processing relating to billing the user for the service after the service person completes the service.

13. A service operation management apparatus comprising:
a service request receiving unit that receives a service request from a user, wherein the service request indicates willingness of the user to receive a service;
a recruiting unit that advertises for recruiting a service person based on the received service request;
an authenticating unit that performs authentication of service persons who have applied for the post of the service person; and
a dispatching unit that dispatches a service person authenticated by the authenticating unit to the user.

14. The service operation management apparatus according to claim 13, wherein the recruiting unit performs the advertisement by transmitting recruiting information to a portable terminal carried by each of a plurality of service persons.

15. The service operation management apparatus according to claim 14, wherein the recruiting unit performs the advertisement with respect to all of the service persons by a broadcast method.

16. The service operation management apparatus according to claim 14, wherein the recruiting unit performs the advertisement with respect to specific service persons selected beforehand by a multicast method.

17. The service operation management apparatus according to claim 13, wherein the authenticating unit carries out the authentication based on a comparison between authentication information registered in advance and authentication information input by the service person in response to the advertisement.

18. The service operation management apparatus according to claim 14, further comprising a progress management unit that receives a state of the service person and status information representing progress of the service in detail from the portable terminal carried by the service person dispatched to the user, to thereby perform progress management.

19. The service operation management apparatus according to claim 17, further comprising a progress management unit that receives a state of the service person and status information representing progress of the service in detail from the portable terminal carried by the service person dispatched to the user, to thereby perform progress management.

20. The service operation management apparatus according to claim 18, wherein the progress management unit receives the status information transmitted from the portable terminal, according to a menu selection method by the service person.

21. The service operation management apparatus according to claim 19, wherein the progress management unit receives the status information transmitted from the portable terminal, according to a menu selection method by the service person.

22. The service operation management apparatus according to claim 18, wherein the progress management unit receives information relating to the content of the service provided by the service person, from the portable terminal.

23. The service operation management apparatus according to claim 19, wherein the progress management unit receives information relating to the content of the service provided by the service person, from the portable terminal.

24. The service operation management apparatus according to claim 13, further comprising a billing unit that executes processing relating to billing the user for the service after the service person completes the service.

25. A service operation management method comprising:
receiving a service request from a user, wherein the service request indicates willingness of the user to receive a service;
advertising for recruiting a service person based on the received service request;
performing authentication of service persons who have applied for the post of the service person; and
dispatching a service person authenticated at the authentication step to the user.

26. The service operation management method according to claim 25, wherein the advertisement is performed by transmitting recruiting information to a portable terminal carried by each of a plurality of service persons.

27. The service operation management method according to claim 26, wherein the advertisement is performed with respect to all of the service persons by a broadcast method.

28. The service operation management method according to claim 26, wherein the advertisement is performed with respect to selected service persons by a multicast method.

29. The service operation management method according to claim 25, wherein the authentication is carried out based on a comparison between authentication information registered in advance and authentication information input by the service person in response to the advertisement.

30. The service operation management method according to claim 26, further comprising of receiving a state of the service person and status information representing progress of the service in detail from the portable terminal carried by the service person dispatched to the user, and managing the progress of the service.

31. The service operation management method according to claim 29, further comprising of receiving a state of the service person and status information representing progress of the service in detail from the portable terminal carried by the service person dispatched to the user, and managing the progress of the service.

32. The service operation management method according to claim 30, wherein the status information transmitted from the portable terminal is received, according to a menu selection method by the service person.

33. The service operation management method according to claim 31, wherein the status information transmitted from the portable terminal is received, according to a menu selection method by the service person.

34. The service operation management method according to claim 30, wherein information relating to the content of the service provided by the service person is received from the portable terminal.

35. The service operation management method according to claim 31, wherein information relating to the content of the service provided by the service person is received from the portable terminal.

36. The service operation management method according to claim 25, further comprising of executing processing relating to billing the user for the service after the service person completes the service.
